(19) United States
(12) Patent Application Publication
(10) Pub. No.: US 2025/0326182 A1
(43) Pub. Date: Oct. 23, 2025

(54) Method and Device for Generating Control Data for a Device for Additively Manufacturing a Component

(71) Applicant: EOS GMBH ELECTRO OPTICAL SYSTEMS, Krailling (DE)

(72) Inventors: Dominik Kunz, Gauting (DE); Harald Krauss, Gersthofen (DE); Michael Jan Galba, Puchheim (DE)

(21) Appl. No.: 18/868,159

(22) PCT Filed: Jun. 1, 2023
(86) PCT No.: PCT/EP2023/064657

§ 371 Date: Nov. 21, 2024

(30) Foreign Application Priority Data
Jun. 3, 2022 (DE) 102022114196.9

(51) Int. Cl. B29C 64/393; B29C 64/153; B33Y 10/00; B33Y 50/02

(52) U.S. Cl. CPC B29C 64/393; B29C 64/153; B33Y 10/00; B33Y 50/02

(57) ABSTRACT

The invention relates to a method for generating control data (PS) for a device (1) for additive manufacturing of a component (2) in a manufacturing process, in which building material (13), preferably comprising a metal powder, is built up layer by layer in a construction field (8) by selective solidification of building material (13) by irradiation of the building material (13) with at least one energy beam (22), the method comprising the steps:
recording of a process room sensor data set (SD) with spatially resolved thermal data of a currently solidified component layer (B),
providing a process room control data set (KD) with an intended shape (F) of the currently solidified component layer (B),
defining a number of special areas(S) in the intended shape (F),
assigning the number of special areas(S) to corresponding areas in the process room sensor data set (SD),
generating a correction factor module (KK), wherein correction factors (KF) in the special areas(S) are generated according to different rules than in other areas of the intended shape (F) outside the special areas(S),
correcting control data (PS) for the additive manufacturing of a subsequent component layer (B1) based on the correction factor module (KK),
outputting the corrected control data (PS) to a device (1) for additive manufacturing of a component (2).

The invention also relates to corresponding control data, a method for additive manufacturing, a control data generation device, a control device and a manufacturing device.

The invention relates to a method and a device (“control data generation device”) for generating control data for a device for additive manufacturing of a component in a manufacturing process, in which the component is built up in a construction field in the form of component layers by selective solidification of building material by irradiation of the building material with at least one energy beam. The invention further relates to corresponding control data, a method for the additive manufacturing of a component with such control data, a device for additive manufacturing, and a control device for such a device.

Additive manufacturing processes are becoming increasingly relevant in the production of prototypes and now also in series production. In general, “additive manufacturing processes” are manufacturing processes in which a manufacturing product (“component”) is built up on the basis of digital 3D design data by depositing material (the “building material”). The structure is usually, but not necessarily, built up in layers. The term “3D printing” is often used as a synonym for additive manufacturing, the production of models, samples and prototypes using additive manufacturing processes is often referred to as “rapid prototyping”, the production of tools as “rapid tooling” and the flexible production of series components as “rapid manufacturing”. As mentioned at the beginning, a key point is the selective solidification of the building material, wherein this solidification can take place in many manufacturing processes with the help of irradiation with radiation energy, e.g. electromagnetic radiation, in particular light and/or heat radiation, but possibly also with particle radiation such as electron radiation. Examples of processes using irradiation are “selective laser sintering” or “selective laser melting”. In this process, thin layers of a mostly powdery building material are repeatedly applied on top of each other and in each layer the building material is selectively solidified in a “welding process” by spatially limited irradiation of the areas that are to be part of the component to be manufactured after production, in which the powder grains of the building material are partially or completely melted with the help of the energy introduced locally by the radiation at this point. During cooling, these powder grains then solidify together to form a solid. In most cases, the energy beam is guided along solidification paths across the construction field and the remelting or solidification of the building material in the respective layer takes place in the form of “weld paths” or “weld beads”, so that ultimately a large number of such layers formed from weld paths are present in the component. In this way, components with very high quality and breaking strength can now be produced.

During production, the case may occur that the energy introduced by the energy beam may be absorbed inhomogeneously by the component. This manifests itself in areas of a component layer with an inhomogeneous heat distribution. Sometimes it may be desirable to solidify selected areas with a different energy input, but this is generally undesirable, especially in the case of uniform surfaces or regular contours.

It is an object of the present invention to provide a method and a device for generating control data for a device for additive manufacturing of a component, which overcomes the disadvantages of the prior art and in particular allows an improvement in the quality of a component. A preferred task of the invention is to increase the stability of the manufacturing process and, in particular, to prevent an interruption of the manufacturing process or to prevent problems with the application of the building material at locations with increased heat generation or radiation. A further preferred task is to reduce the support volume (and thus the part costs) and thus increase the process speed, which has a beneficial effect on the component costs.

This object is solved by a method according to patent claim 1, control data according to patent claim 10, a manufacturing method for additive manufacturing according to patent claim 11, a control data generation device according to patent claim 12, a control device according to patent claim 13 and a device according to patent claim 14.

A method according to the invention serves to generate control data for a device for the additive manufacturing of a component in a manufacturing process in which the component is built up in a construction field in the form of component layers by selective solidification of building material by irradiating the building material with at least one energy beam. Although the control data does not yet represent a finished component, it does represent a component, because a component consists of layers of solidification paths that have been solidified in accordance with the control data.

The method according to the invention comprises the following steps:
Recording of a process room sensor data set with spatially resolved thermal data of a currently solidified component layer,
providing a process room control data set of a currently solidified component layer of the component by means of a sensor arrangement, wherein the process room sensor data set comprises at least spatially resolved thermal data of a number of regions of this component layer,
providing a process room control data set comprising information on an intended shape of the currently solidified component layer,
defining a number of special areas in the intended shape, each special area being an area having predetermined, systematic shape features and/or manufacturing features in the component layer,
assigning the number of special areas to corresponding areas of the number of areas in the process room sensor data set,
generating a correction factor module which assigns correction factors or the corrected irradiation values to at least a partial area of a subsequent component layer, wherein the correction factors or corrected irradiation values are generated from the process room sensor data set and are generated in the special areas according to different rules than outside the special areas,
correcting control data for the additive manufacturing of a subsequent component layer based on the correction factor module,
outputting the corrected control data to a device for additive manufacturing of a component.

As already indicated, in a production process in a construction field, material is built up layer by layer, i.e. successively in several material application levels or material layers. The building material is preferably a metal powder or at least a metal-based powder. Such a powder preferably contains more than 50% weight by weight of metal, in particular more than 60% w/w, 70% w/w, 80% w/w or even more than 90% w/w of metal. However, the invention is not limited to this, but can also be used with other, preferably powdery, construction materials, such as plastics or ceramics or mixtures of the various materials. In this process, building material is solidified (in particular selectively), in particular between the application of two layers of material, by irradiating the building material with at least one energy beam generated by an irradiation unit of the manufacturing device (this refers to an energetic beam of photons or particles, e.g. a light beam or an electron beam). Not only is the build-up material in the uppermost, freshly applied material layer captured by the energy beam and melted or remelted, but the energy beam usually goes a little deeper into the material bed and also reaches underlying, already remelted material from previously applied material layers.

The process room sensor data set with the thermal data can be recorded, for example, using a thermal imaging camera, e.g. a CMOS camera with a spectral filter in the near-infrared range, but this is not absolutely necessary. A scanning measurement method can also be used, in which a spatial resolution—alone or additionally—is given by a respective scan position, and/or a measurement method in which the sensor is arranged in the beam path of the processing machine (on axis) and the spatial resolution—alone or additionally—is given by a current processing position. Spatially resolved “heat data” refers to information on the heat distribution in at least one area of the component layer or an entire component layer. Information on various points of the component layer must be available together with the position of these points. For example, an infrared image of the component layer could represent the heat data, since heat information is assigned to points of the component layer in this image. However, the thermal data does not necessarily have to be a thermal image from a thermal camera, but can be obtained in other ways. The process room sensor data set therefore shows, for example, a component layer or at least a component area in this component layer as a thermal image.

The absolute temperature does not necessarily have to be measured directly for the heat data; the pixel values of a temperature-sensitive camera (i.e. basically the “gray values”) are sufficient. From their evaluation alone, the temperature can already be well estimated. The heat data can reflect a temperature in both absolute and relative values. Typically, a baseline for the temperature values (gray values) is measured for a machine or a construction process (even on different machines) and the temperature is estimated based on a change relative to the baseline. This change can be “small” (e.g. for very high baselines) or “large” (e.g. for very low baselines).

The process room control data set contains data on the geometric shape of the component layer under consideration and/or on irradiation paths for the production of this component layer (intended shape). The term “provide” in relation to the process room control data set means that it can be easily obtained, e.g. if the data is already available from another source, or can be generated, e.g. from CAD data of a component or from control data. In short, the intended shape should allow reconstruction of the component layer in question. For example, the process room control data set relating to the intended shape may comprise parallel sections of a CAD-generated component (at least one section) or scan vectors for manufacturing a component layer (or many component layers) of a component.

In principle, this information would already be sufficient to keep inhomogeneities in the energy input as low as possible. The energy input is therefore measured during the production process using a sensor arrangement, e.g. by measuring the thermal radiation of a component layer with a radiation sensor. Areas with excessive heat radiation can then be detected in these measurements and the corresponding areas can be solidified in the subsequent component layer with a lower energy input. The same applies to areas that radiate too little heat. In this way, inhomogeneities can be compensated iteratively.

However, this compensation cannot be optimally applied in some areas of a component, since the data from the sensor arrangement does not necessarily reflect correct values for the actual thermal radiation or these areas “work” thermally differently to other areas. These are, for example, areas with corners or sharp curves in the component, edge areas of the component or very small structures within a component. In general, it can be said that wherever there is a risk that the resolution of the sensor arrangement does not allow an exact separation of areas with different energy input or where an energy input that differs from the environment is specifically desired, this general method cannot provide optimum compensation for inhomogeneities. These areas are particularly edge areas, i.e. where there is a large energy input for solidification on one side and no energy input on the other side, as no solidification is to take place. However, these areas can also be areas in which strips of hatching overlap and appear conspicuous in a layer-by-layer integrating sensor system, although they do not have to be in reality.

Such an area is referred to as a “special area” in the context of the invention, as it requires special attention so that compensation for inhomogeneities can be carried out as well as possible. Each special area is an area with predetermined, systematic shape and/or manufacturing features in the component layer. Shape features are features relating to the geometric shape or position, e.g. that the area is located at the edge of a cross-section of a component to be solidified, the area is smaller than the resolution of the sensor arrangement or is imaged with insufficient precision by the sensor arrangement or special thermal conditions dominate in the area due to the shape or due to a position on or near a surface of the later component, e.g. in the case of tight curves or tapers. Manufacturing features would be, for example, an overlap of solidification paths in a component layer, a local increase in the spacing of the solidification paths in a component layer, a local change in the thickness or depth of solidification paths or local changes in the irradiation (e.g. by pulses or by selecting a different process frame, such as local bonding by means of heat conduction welding with a general selection of the deep welding process). Special shape features and manufacturing features may also be present in combination, since a special local manufacturing mode may be selected due to a special shape. The term “predetermined systematic” means that it is already apparent from the process room control data set (and possibly from experience in the manufacture of components) that special thermal conditions dominate in these areas during production. For example, the edge of a component represents a thermally problematic area. A special area could also be referred to as a (systematically special) “overheating area”, “error heating area”, “deviation area” or “special correction area”. In particular, a special area can be an area that requires or would require post-treatment if it does not experience an increased temperature during production.

With regard to a particular aspect of the invention, a special area may be an area that is to be thermally post-treated or that is solidified with different parameters (e.g. laser parameters: beam profile, laser intensity) during the manufacture of the component in order to change/improve its properties or the properties of the component (e.g. hardness, mechanical strength, density, etc.).

These special areas are preferably defined automatically for corresponding areas of the intended shape, e.g. by automatically classifying each edge area of a component layer of the intended shape with a predefined width, each overlap area or each clearly defined area below a predefined volume or a predefined area in the construction plane as a special area. What exactly is to be classified as a special area can, for example, be taken from a predefined list but could also be specified manually by a user input. It is particularly preferable, if a user can enter or change the parameters for the automatic classification of special areas by means of changeable default settings.

These special areas are therefore initially defined in a non-material environment (intended shape). As this intended shape corresponds to the (real) component layer represented by the process room sensor data set, it must now be determined which parts of the component layer in question are to be regarded as special areas. This is achieved by the subsequent assignment. The process room sensor data set contains spatially resolved thermal data from a number of areas of the component layer. In the following, this is referred to as a “thermal image of the component layer” for better understanding, although this term does not exclude other ways in which spatially resolved thermal data of a number of areas of the component layer could be available.

This assignment of the special areas to corresponding areas of the “thermal image of the component layer” is preferably carried out automatically, e.g. by automatically classifying each area of the thermal image whose correspondence in the intended shape has been classified as a special area also as a special area in the thermal image. This assignment can be made purely information-technically by adding a marker to an area of the thermal image of the component layer to indicate that this is a special area or by adding a marker to this area in an image (e.g. a special color). A mask can also be created to indicate which areas in the thermal image of the component layer are to be considered special areas. How exactly the information on the special area is assigned to the intended shape (e.g. by a data link or by mapping) is basically irrelevant as long as it is then clear which areas of the thermal image of the component layer are to be regarded as special areas and which are not. It is therefore clear which thermal data of the spatially resolved thermal data are in a special area and which are not.

The subsequently generated correction factor module assigns correction factors or corrected irradiation values, which are generated from the process room sensor data set, to at least one sub-area of a (directly) subsequent component layer (i.e. directly on the other component layer after its production). The correction factor module preferably comprises a program and/or a database, wherein the program preferably comprises automated access to a database, wherein the access comprises using and/or modifying and/or storing and/or overwriting data based at least on the process room sensor data set and/or the process room control data set. The correction factors act in particular on a power and/or a focus diameter of the energy beam and/or its beam profile or intensity distribution and/or a scan speed and/or a hatch distance. If the energy beam is a laser beam, the term “laser correction factor” (or LCF) or “laser power correction factor” can also be used. However, a restriction to a laser power is not necessary, as the energy input should basically be adjusted. The correction factor module could therefore also be referred to as the “energy input parameter module” or “volume energy module”, e.g. with a volume energy as the reference variable.

A “module” in the sense of the correction factor module is an element that is used in accordance with its intended purpose for the application or collection of a plurality or multiplicity of correction factors. It can simply contain data which are the correction factors or from which the correction factors can be determined, but also a functionality with which correction factors can be determined or even applied to control commands. The module itself can be software-implemented, e.g. in the form of a table, function, list or data set, or hardware-implemented, e.g. in the form of an FPGA or a processor or controller with a memory unit. Preferably, the correction factor module is thus a software-based or hardware-based element which comprises data in the form of correction factors or comprises data and/or functions by means of which the correction factors can be determined.

The correction factor module can be present in the form of a correction factor map, which has the correction factors in the form of a matrix. If, for example, a digital thermal image of the component layer exists, the correction factor map may well comprise pixels or raster cells, which correspond in particular to the pixels in the thermal image, and instead of color values or gray values comprise scalar values that specify correction factors.

Alternatively or additionally, the correction factor module can also be in the form of a correction factor function KF, which is preferably a two-dimensional function. The correction factors at a two-dimensional spatial position (x, y) in the component layer can then simply be the functional values of the correction factor function KF (x, y) at the corresponding positions. The correction factor function can, for example, be generated from a correction factor map by a fit of a two-dimensional polynomial function. Even if the generation is more complicated than that of a map, a function has the advantage of requiring less memory, since only function coefficients have to be stored, and of a better scalability. The use of such a correction factor function can also have advantages for a correction without taking the special areas into account. A corresponding method then comprises the following steps as an alternative:
Optional: Assigning the number of special areas to corresponding areas of the number of areas in the process room sensor data set,
generating a correction factor function which assigns correction factors or corrected irradiation values to at least a partial area of a subsequent component layer, wherein the correction factors or the corrected irradiation values are generated from the process room sensor data set and are preferably generated in the special areas according to different rules than in other areas of the intended shape outside the special areas,
correcting control data for the additive manufacturing of a subsequent component layer based on the correction factor function.

What is important here for the method according to the invention is that the correction factors or corrected irradiation values in the special areas are generated according to different rules than in other areas of the intended shape outside the special areas. This is due to the fact that “other rules” also apply in the special areas. For example, the data from pixels of a thermal imaging camera reflect the heat that has been radiated from a surface area on the construction plane. A first pixel, which has recorded an unconsolidated area, shows less heat than a second pixel, which has recorded an area that has just been consolidated. However, a third pixel, which has recorded an edge area with solidified and unsolidified areas, will show a lower heat than the second pixel and a higher heat than the first pixel, even if the solidified area should be equally warm everywhere. This is because the pixels show an integral of the thermal radiation of the area they have captured. In a case where the second pixel (not a special area) would indicate that the area it picks up is too hot, a corresponding correction factor would indicate that less energy should be introduced there in the next layer. For the third pixel (special area, here adjacent to the second pixel), which is considered to be colder, although there is too much heat in the solidified area, as a part of the unsolidified area has also been recorded, no correction factor would be applied without a separate treatment (or a correction factor of 1), as no overheating has been detected. However, the correct thing to do here would be to apply the same correction factor that is applied to the second pixel. This is exactly what the method according to the invention takes into account by generating the correction factors or corrected irradiation values in the special areas according to different rules than in other areas of the intended shape outside the special areas.

The exact nature of these other rules may depend on the component, the building material used, the type of irradiation and the type of special area. Some preferred embodiments are mentioned below. In a very simple embodiment, for example, the correction factors of neighboring areas of the intended shape can be used for the special areas.

The correction factor module (KF module for short) does not have to refer to the entire construction field. Different areas of the construction field can be corrected by different KF modules. For example, an overall correction map can be formed from a combination of correction factor maps (KF maps). A construction process is preferably controlled pixel by pixel according to points on these KF maps, wherein the higher the resolution of a KF map, the better the control. Accordingly, a group of correction factor functions can also be used, with each correction factor function being applied to an area of the construction field. Preferably, fixed irradiance values are corrected with the correction factor during manufacturing and/or the correction factor directly provides the irradiance values. The correction factor is preferably a relative correction factor which is multiplied by a predetermined laser power or by which a predetermined laser power is divided.

The same applies to the corrected irradiation values as to the correction factors, as they are simply irradiation values that have already been corrected using (these) correction factors. The correction factor module can therefore comprise correction factors that are then used to correct irradiation values or irradiation values that have already been corrected. It is clear that the correction factors are selected in such a way that if the energy input at one point in the subsequent layer is too high, a lower energy input occurs at this point, which is calculated in particular in such a way that a desired energy input occurs.

In order to compensate for inhomogeneities, a subsequent component layer must be irradiated. In the event that the subsequent component layer still exhibits inhomogeneities after it has been manufactured, the process can be carried out for the next component layer based on the component layer that has just been produced. After a few iterations, it will be possible to homogenize the energy input if the correction factors are chosen reasonably.

Control data for the additive manufacturing of a subsequent component layer are therefore corrected based on the correction factor module (e.g. a correction factor map or function) and the corrected control data are output to a device for additive manufacturing of a component so that a new component layer can be manufactured. This new component layer or a process room sensor data set of this new component layer should now serve as the basis for a new run of the process for the next component layer.

The KF module can be saved last, in particular after the component has been manufactured, and used to manufacture further components. If the KF module does not include correction methods, but corrected irradiation data (and particularly preferably corrected control data), it could be regarded as control data according to the invention.

The method described above can be used to generate control data according to the invention, which is used to control a device for additive manufacturing. As mentioned, this control data is characterized by the fact that it is corrected so that inhomogeneities in the temperature distribution during production are compensated. It should be noted that it is not the temperature distribution itself that is compensated, but rather the inhomogeneous temperature distribution of a current layer is taken into account for compensating irradiation in the subsequent layer. Strictly speaking, not only the heat balance of a single layer is regulated, but also the heat balance of many already solidified layers with a correspondingly lower effect, up to the overall heat balance of a component or even the simultaneous production of several components. The reason for this is that layers that have already solidified usually continue to emit heat, as the heat input into the construction container during the production process usually exceeds the heat outflow from the construction container at least temporarily. With many solidified layers, the effect adds up, which significantly influences the heat radiation of a measured surface. In practice, the correction factors of the correction factor module are usually only combined with the original control data (vectorized) in the machine controller and passed on to an exposure controller as “microsteps” (control signals in the scan cycle of the production device). However, corrected control data can also be used directly.

The control data also preferably includes further design instructions, such as an amount of building material, which may be selectively provided locally for a layer application, and in particular also the lowering of the building platform between the production of the component layers. This is implicitly given in an arrangement of two component layers, as a new component layer can only be applied to an already solidified area by applying new building material. This application usually makes it necessary to lower the building platform.

In a manufacturing method according to the invention for the additive manufacturing of a component, the component is built up layer by layer in a construction field in the form of component layers by selective solidification of building material, preferably comprising a metal sized powder, by irradiating the building material with at least one energy beam in accordance with the control data according to the invention. To create component layers of the component, the energy beam is moved over the construction field in accordance with the control data, i.e. with corrected irradiation parameters.

A control data generation device according to the invention is used to generate control data according to the invention (according to the method according to the invention) for a device for additive manufacturing of a component in a manufacturing process, in which the component is built up in a construction field in the form of component layers by selective modification of building material, preferably comprising a metal-based powder, by irradiating the building material with at least one energy beam.

The control data generation device comprises the following components:
A data interface designed to receive a process room control data set comprising information on an intended shape of the currently solidified component layer, and a process room sensor data set of a currently solidified component layer of the component recorded by means of a sensor arrangement, wherein the process room sensor data set comprises at least spatially resolved thermal data of a number of regions of this component layer,
a registering unit designed to define a number of special areas in the intended shape, each special area being an area having predetermined systematic shape features and/or manufacturing features in the component layer, and for assigning the number of special areas to corresponding areas of the number of areas in the process room sensor data set,
a module unit designed for generating a correction factor module which assigns correction factors or the corrected irradiation values to at least a partial area of a subsequent component layer, wherein the correction factors or corrected irradiation values are generated from the process room sensor data set and are generated in the special areas according to different rules than outside the special areas,
a correction unit designed to correct control data for the additive manufacturing of a subsequent component layer based on the correction factor module,
a data interface (possibly the above-mentioned or another), designed for outputting the corrected control data to a device for additive manufacturing of a component.

The function of the components has already been explained in detail above using the procedure.

A control device according to the invention serves a device for additive manufacturing of a component in a manufacturing process, in which the component is built up in layers in a construction field in the form of component layers by selective solidification of building material, preferably comprising a metal-based powder, by irradiation of the building material with at least one energy beam by means of an irradiation device. The control device is designed to control the device for additive manufacturing of the component layers of the component in accordance with control data according to the invention. Preferably, the control device according to the invention comprises a control data generation device according to the invention.

A device according to the invention (“manufacturing device”) is used for the additive manufacturing of at least one component in an additive manufacturing process. It comprises at least
a feeding device for applying layers of building material to a construction field in a process space,
an irradiation device for selectively solidifying building material by irradiation with at least one energy beam, in particular between the application of two layers of material, and
a control device according to the invention.

It should be pointed out at this point that the device according to the invention can also have several irradiation devices, which are then controlled in a correspondingly coordinated manner with the control data, as mentioned above. It should also be mentioned once again that the energy beam can also consist of several superimposed energy beams or that the energy beam can be both particle radiation and electromagnetic radiation, such as light or preferably laser radiation.

In particular, the invention can be realized in the form of a computer unit, especially in a control device, with suitable software. This refers in particular to the creation of the control data, as the production of a component is carried out by means of further components. The computer unit can, for example, have one or more microprocessors or the like that work together for this purpose. In particular, it can be realized in the form of suitable software program parts in the computer unit. A largely software-based realization has the advantage that previously used computer units, in particular in control devices of manufacturing devices, can also be easily retrofitted by a software or firmware update in order to work in the manner according to the invention. In this respect, the task is also solved by a corresponding computer program product with a computer program which can be loaded directly into a memory device of a computer unit, with program sections to carry out all steps of the method according to the invention (at least those relating to the generation of control data, but possibly also those serving to transmit the control data for a manufacturing process) when the program is executed in the computer unit. In addition to the computer program, such a computer program product may include additional components such as documentation and/or additional components, including hardware components such as hardware keys (dongles, etc.) for using the software. A computer-readable medium, for example a memory stick, a hard disk or another transportable or permanently installed data carrier, on which the program sections of the computer program that can be read in and executed by a computer unit are stored, can be used for transport to the computer unit and/or for storage on or in the computer unit.

Further, particularly advantageous embodiments and further embodiments of the invention result from the dependent claims and the following description, wherein the independent claims of one claim category can also be further developed analogously to the dependent claims and embodiment examples of another claim category and, in particular, individual features of different embodiment examples or variants can also be combined to form new embodiment examples or variants.

According to a preferred method, before assigning the number of special areas to the corresponding areas in the process room sensor data set, the process room sensor data set is adjusted according to existing (previously determined) calibration data or according to an adjustment function (e.g. a fit algorithm). It is preferred that the sensor arrangement is first calibrated and the process room sensor data set is recorded with the calibrated sensor arrangement. Alternatively, it is preferred that predefined calibration data is present and that the process room sensor data set is adjusted after it has been recorded by the sensor arrangement. It is preferred that the special areas are registered to corresponding areas in the process room sensor data set or otherwise mapped there by using an matching algorithm. The latter has the advantage that the sensor data can be calibrated directly depending on whether it originates from a special area or not.

Which area is specifically considered a special area depends on the type of component, the type of production or the user. It may be predetermined, e.g. by default settings or by user specifications, what is to be considered a special area. The following areas of a component are preferred special areas. Individual alternatives or groups of the following alternatives can be selected as defaults for special areas.
A component edge area of the component layer,
an area of the component layer in which solidification paths overlap with each other, in particular their start and/or end areas,
an area in which a hatching strip (possibly consisting of solidification paths arranged parallel to each other, next to each other) tapers (i.e. in which the solidification paths have a shorter length than a standard or maximum length),
an area that is smaller than the optical resolution of the sensor arrangement (i.e. the smallest possible area of the component layer that can be individually measured by the spatially resolving sensor arrangement),
an area with support structures, preferably where a wall thickness or a strut thickness or a diameter of the support structures is smaller than can be fully resolved with the sensor (e.g. <5× pixel resolution, e.g. approx. 500 μm).

According to a preferred method, the assignment number of special areas to the corresponding positions in the process room sensor data set is carried out by means of image registration. A method based on enhanced correlation coefficients (commonly used in image processing) is preferred (see e.g. Georgios D. Evangelidis and Emmanouil Z. Psarakis “Parametric Image Alignment Using Enhanced Correlation Coefficient Maximization”, IEEE transactions on Pattern Analysis and Machine Intelligence, Vol. 30, No. 10, October 2008).

According to a preferred method, the correction factors of the correction factor module for a special area are interpolated or extrapolated from the correction factors for a number of component areas of the intended shape adjacent to the special area. This is done in particular by interpolating correction factors of opposite component areas or by interpolating correction factors of a component area and predetermined values outside the component, or correction factors of a component area. This is also particularly advantageous if the special area is an area where thermal post-treatment is to be carried out.

Alternatively, it is preferred that the correction factors of the correction factor module for a special area are formed from predetermined, constant correction factors.

Alternatively, it is preferred that the correction factors of the correction factor module for a special area are determined by interpolating methods from image processing that are based on a continuous continuation of the gray values, in particular based on coloring algorithms or inpainting algorithms.

Alternatively, it is preferred that the correction factors of the correction factor module for a special area are formed based on a model of a theoretical temperature change or the local heat conduction properties. This is also particularly advantageous if the special area is an area where thermal post-treatment is to be carried out.

According to a preferred method, predetermined maximum and/or minimum values for a correction factor are present, in particular a threshold value module, in particular a threshold value function or a threshold value map with locally resolved maximum and/or minimum values. The correction factors are then preferably generated in such a way that they do not exceed the maximum values and/or do not fall below the minimum values.

According to a preferred method, the correction factors are generated from the process room sensor data set outside the number of special areas by means of a controller, in particular a PD controller, a PI controller or a PID controller, in order to generate a correction factor map. It is preferred that the correction factors are generated within a special area, i.e. where they are generated according to different rules than in other areas:
are generated without the controller, or
are first generated using the controller and then corrected or
the corresponding values of the process room sensor data set are first corrected and then the correction factors are generated using the controller.

For a correction in the non-special area, the controller is preferably used classically, using parameterizable proportional, differential and/or integral components. It is particularly preferable for the control to be completely SW-based. In particular, the parameters of the controller can be set on a component-specific basis.

As already indicated above, the method is preferably used for several successive component layers. Control data is preferably stored together with a number of corresponding correction factor modules and/or with corrected control data. It should be noted here that the correction factor modules may already contain corrected irradiation values, but the corrected control data may contain further data than the corrected irradiation values. It is particularly preferable to store all correction factor modules or corrected control data obtained by the method, as they are interrelated. Finally, a process room sensor data set is obtained from a component layer produced with corrected control data after previous application of the method.

It is preferred for the correction of control data for a component to use only data from the correction factor module that was generated from a component layer of that particular component, in particular from the immediately preceding component layer. Each component is therefore considered separately. Alternatively, data from a correction factor module generated from a uniform component layer of another component is preferably used. This allows the correction factor module of one of the components to be applied to the other components, e.g. when manufacturing several components of the same type.

It should be noted here that the method according to the invention can also be applied to control data that has already been corrected, provided that it is known that it has already been corrected and in what way. Basically, only the correction factors need to be designed accordingly. For example, corrected control data that has been obtained from one component can undergo an additional correction when applied to another component. Alternatively, corrected control data that has been obtained from a component that, for example, has the same shape, is to be made from the same material and has the same requirements with regard to its component properties, can undergo an additional correction when applied to another example of this component. However, control data that has been corrected without taking special areas into account can now also be optimized using the method, e.g. by correcting only the special areas and retaining the other correction factors.

According to a preferred method, information on a shape and/or position of the subsequent component layer is provided in addition to a process room control data set to determine a number of special areas in the currently solidified component layer. Correction factors, in particular for downskin areas, i.e. surface areas or near-surface areas of a component that lie above and adjacent to unconsolidated powder in the production process in the production device, are then preferably derived from the process room control data sets of both component layers. When selecting the special areas, the subsequent component layer is also considered, i.e. basically the intended shapes of these component layers.

The invention has the additional advantage that reduced cooling times can be expected at least during the production of components. In addition, production can also be carried out with a higher packing density, as temperature related distances between components can be reduced.

So far, particular emphasis has been placed on embodiments that correct the control data in such a way that inhomogeneities in the temperature distribution during production are compensated for. However, it is also possible to deliberately set a different temperature in one special area than in another (neighboring) area by means of a correction.

Unwanted internal stresses often arise in a component, which can lead to disadvantageous component properties such as cracks or deformations. In order to resolve or reduce such stresses, the component can be heat treated, e.g. in the case of metallic components by post-annealing with optional subsequent quenching. Depending on the desired quality, subsequent heat treatment may even be mandatory. After production, the components are heated in a furnace to a temperature determined before and then cooled in a liquid bath if necessary. For heat treatment, the temperature in the chamber is usually between 300° C. and 350° C. A common temperature for the production of metal parts is between 250-300° C.

Another preferred embodiment addresses this problem and solves the task of setting a desired component property in the component by means of a different heat distribution of areas of the layers. Such a component property is preferably a special structure of the internal microstructure and/or an internal stress structure or a further mechanical property. A mechanical property may in particular be a predetermined hardness, a mechanical strength, a density and/or a porosity of the component. It is a particular task to produce a component with areas of different microstructure, which determines the mechanical properties of the component.

A particular task which could be solved by the invention would be the production of a component in which a special area with a smaller porosity should be built by heat treatment, which has a better hardness and/or mechanical strength due to its greater density.

Another special object would be the production of a component in which the mechanical strength is also to be influenced by the (different) microstructure of the component areas. It should be noted that the term “microstructure” can refer both to grains adhering together and to a crystal structure. A grain does not necessarily have to be a crystal, but can certainly be part of a crystal structure (e.g. the grain size of metals). A structure can be determined by a (relative or absolute) arrangement and/or by a (relative or absolute) size and/or by a shape of the crystals or grains.

Another special task would be the production of a component in which internal stresses are to be resolved. This usually involves stresses that form during cooling of the component. However, internal stresses can also be produced in an intended manner.

With the following preferred embodiments, the step of subsequent heat treatment, e.g. post-annealing, can be avoided or simplified. This requires that the component has a (possibly much) higher temperature during its production than is normally intended during its production, at least in some partial areas.

A special area can be used, as preferred above, to produce a particularly homogeneous temperature distribution during production. This special area could also be referred to as a “homogeneity special area”. A special area intended for heat treatment could also be referred to as a “heat treatment special area”.

When determining the number of special areas, this number of special areas may include a number of homogeneity special areas and/or a number of heat treatment special areas (possibly both types of special areas). A predetermined, systematic manufacturing feature of a heat treatment special area may be the production or release of an internal stress or the production of a predetermined microstructure. In practice, the heat treatment special areas in particular are usually predetermined.

Both types of special areas may well be present in one component layer. Preferably, a heat treatment special area also has a homogeneity special area that corresponds to a sub-area, in particular the edge, of the heat treatment special area. This homogeneity special area has the advantage that the heat treatment special area can be treated very homogeneously at a (predetermined) temperature.

Regardless of the type of special area, the assignment to the process room sensor data set is always the same.

As far as a correction factor module is concerned, this can be referred to as a “homogeneity correction factor module” or a “heat treatment correction factor module” depending on the respective special area. A homogeneity correction factor module is used to make the temperature as homogeneous as possible over an area of the component layer, a heat treatment correction factor module is used to modify the specified temperature so that a heat treatment is carried out in a special area during production by introducing a specified power there before, and/or during and/or after solidification and heating the special area there more or less than the surrounding areas or a number of further times. A heat treatment correction factor module may well lead to a correction in which a special area is irradiated two or more times (e.g. once for solidification and then and/or before for heat treatment) instead of just once (at a higher or lower temperature).

If a homogeneity correction factor module is therefore used to ensure that the assigned correction factors or corrected irradiation values lead to homogeneous production, the heat treatment correction factor module is used to assign correction factors or corrected irradiation values with which a special area in question is produced or treated at a different temperature than the surrounding areas.

In a preferred case, the control data that is corrected is already designed so that the heat treatment (e.g. post-annealing for components made of metal) takes place during production. The correction then ensures that this heat treatment takes place homogeneously in the component and/or ensures that the desired temperature or the temperature required for heat treatment is reached during production. The areas in which heat treatment should occur are preferably larger than the special areas or the special areas are part of the areas in which heat treatment should occur. The special areas here are therefore basically homogeneity special areas.

A laser power greater than 400 W, in particular greater than 600 W or even greater than 800 W, is preferred for heat treatment. However, the laser power is preferably less than 1200 W, in particular less than 1100 W or even less than 1000 W. A preferred focus diameter is greater than 60 μm, in particular greater than 80 μm or even greater than 100 μm. However, the focus diameter is preferably smaller than 10 mm, in particular smaller than 1 mm. Particularly preferred focus diameters are smaller than 260 μm, especially smaller than 220 μm or even smaller than 180 μm.

In the case where conventional control data is used, the correction factor module is basically the heat treatment correction factor module mentioned above. This module assigns a correction factor or a corrected irradiation value that comprises a predetermined radiation power. It is preferred that a homogeneity correction factor module is used in addition to the heat treatment correction factor module when correcting the control data.

A heat treatment correction factor module thus assigns correction factors or corrected irradiation values for heat treatment of the special area in question, which raise or lower the temperature before and/or during and/or after solidification of the special area in such a way that the special area in question is manufactured at a higher or lower temperature than neighboring areas, so that heat treatment takes place there during manufacture.

It is noted that in the case that both a homogeneity correction factor module and a heat treatment correction factor module assign corrected irradiation values, these two modules should take irradiation values into account when correcting the control data. In particular, values could be added, e.g. by adding time durations that are specified for a beam guidance, so that the beam requires a longer time to travel along a path, i.e. introduces more heat there. However, the heat treatment correction factor module can also ensure that the beam is irradiated a second time. The homogeneity correction factor module can ensure that a homogeneity special area within a heat treatment special area is heat treated differently from its surroundings in order to achieve a particularly homogeneous heat treatment.

With this embodiment, it is possible to carry out a special heat treatment to adjust other component properties. Selected special areas of the component are specifically heat-treated at a different temperature than others. For example, an inner area can be heated more or less than an outer area, or areas in which different forces are expected to dominate when the component is later used are heat-treated differently to other component areas.

This allows some areas of the component to be specifically made softer or harder or more brittle or elastic than other areas of the component. In particular, different areas can be heat-treated differently so that they have a different microstructure.

This can also be achieved with pre-prepared control data. However, when correcting the control data, care must be taken to ensure that when the correction factor module is generated, its correction factors are generated in such a way that a temperature distribution is achieved in the relevant sub-area of a subsequent component layer that is specified by the prefabricated control data. Incidentally, this should not only be done for a special temperature treatment, but also for “normal” production, if different production temperatures are required. Corrected irradiation values could also be assigned directly instead of the correction factors. However, these must then be based on the predefined control data and should be designed in such a way that the desired temperature profile is achieved.

In a heat treatment (in the oven) according to the state of the art, a compromise must be found for parameters depending on the properties of the resulting component: some areas may require a stronger heat treatment, while others should receive a weaker one. In the furnace, however, only an average temperature can be achieved over the component. A heat treatment according to the invention allows sub-areas of the component to receive heat treatments at different temperatures. These partial areas can, for example, be areas that should have better mechanical properties and/or a different microstructure than other areas. Areas can also be specifically excluded from the heat treatment or reheated. It is preferable for areas that have already been hardened to be reheated after hardening (possibly more times). In this case, the heat treatment is therefore carried out by this additional heating.

According to a preferred embodiment, “normal” control data is used for the additive manufacturing of a subsequent component layer and this is then corrected based on the heat treatment correction factor module (e.g. a heat treatment map or-function). The heat treatment correction factor module particularly preferably specifies an inhomogeneous irradiation (for the inhomogeneous heat treatment).

The control data corrected in this way is then output to a device for additive manufacturing of a component so that a new component layer can be manufactured. This new component layer or a process room sensor data set of this new component layer then preferably serves as the basis for a new run of the process for the next component layer.

Preferably, the cooling of areas of a component layer is controlled by setting the laser parameters so that internal stresses are reduced or avoided by means of a desired controlled cooling behavior. However, depending on the component, it is also preferable to control the cooling behavior by adjusting the laser parameters in such a way that stresses are specifically created. It can also be advantageous to intentionally induce internal stresses so that the resulting component has certain properties (similar to tempered glass).

An increased temperature is preferably achieved by adjusting the laser power and/or the beam profile.

A special area that experiences a higher effective temperature during manufacture due to the beam deformation or intensity change (i.e. an area that is to undergo heat treatment) could be referred to here as a “superheat area”, where the superheat is intentionally induced by changing the radiation.

It is also preferred within the scope of the invention that the laser intensity is gradually reduced in some special areas so that the component or a partial area of the component is cooled in a controlled manner.

Finally, the (heat treatment) correction factor module can be saved, especially after the component has been manufactured, and used to manufacture further components.

Looking at the method according to the invention, a preferred embodiment, in which the heat treatment takes place in the course of a correction of “normal” control data, could look like this:
Generating a heat treatment correction factor module which assigns correction factors or corrected irradiation values for a heat treatment to at least a partial area of a subsequent component layer, wherein the correction factors or the corrected irradiation values for the heat treatment are generated from predetermined conditions and are generated in at least some of the special areas according to different rules than in other areas of the intended shape outside the special areas,
(preferably additionally: ) generating a homogeneity correction factor module which assigns correction factors or corrected irradiation values to at least a partial area of a subsequent component layer, wherein the correction factors or the corrected irradiation values are generated from the process room sensor data set and are generated in the special areas according to different rules than in other areas of the intended shape outside the special areas,
correcting control data for the additive manufacturing of a subsequent component layer based on the homogeneity correction factor module and the heat treatment correction factor module,
outputting the corrected control data to a device for additive manufacturing of a component.

In short, these special embodiments allow a certain high temperature level to be maintained globally or locally across the component over the duration of the construction process. In the case of local differentiation, specific areas can be created that have different local properties than the overall component. In principle, a big-spot or beam-shaping process, for example, is better suited to this than a standard process, as significantly more power is available to build a part significantly “hotter” than necessary. As a result, subsequent heat treatment can be saved or can be used to adapt the component properties in another special way, e.g. by hardening the wall area of the component again.

The invention is explained in more detail below with reference to the attached figures using examples of embodiments. In the various figures, identical components are provided with identical reference numerals. The figures show

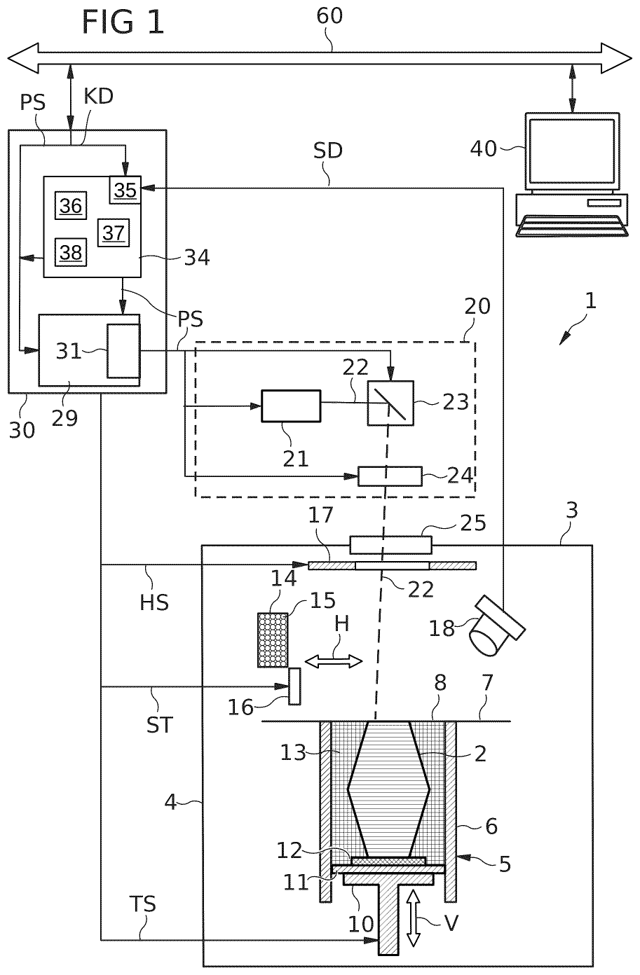

FIG. 1 a schematic view, partially shown in section, of an example of a device for additive manufacturing,

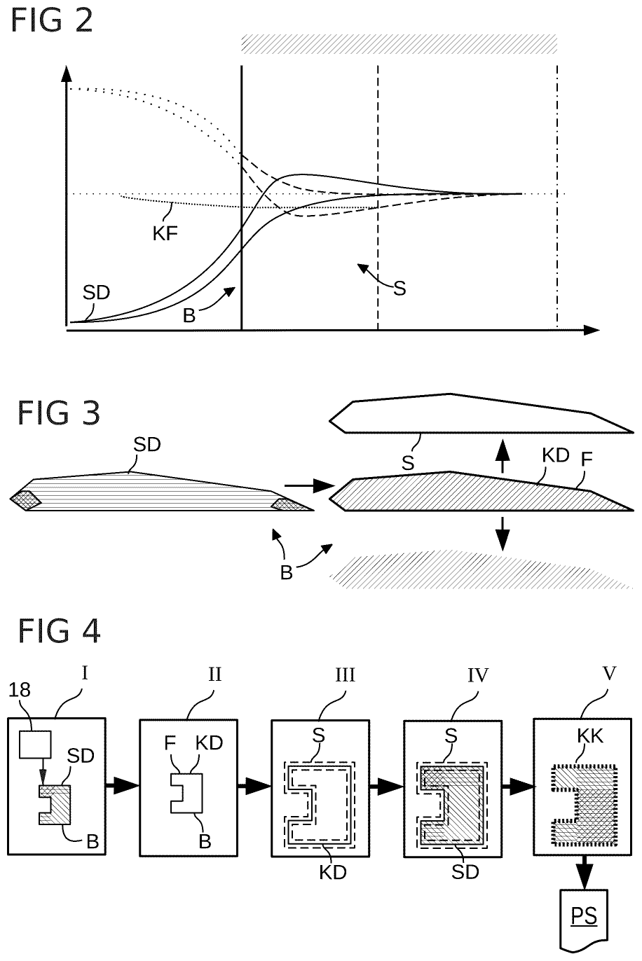

FIG. 2 a sketch for an energy input and correction factors at the edge of a component layer,

FIG. 3 a possible process room sensor data set for a component layer and its intended shape,

FIG. 4 a block diagram of a possible process sequence of an embodiment of a method according to the invention,

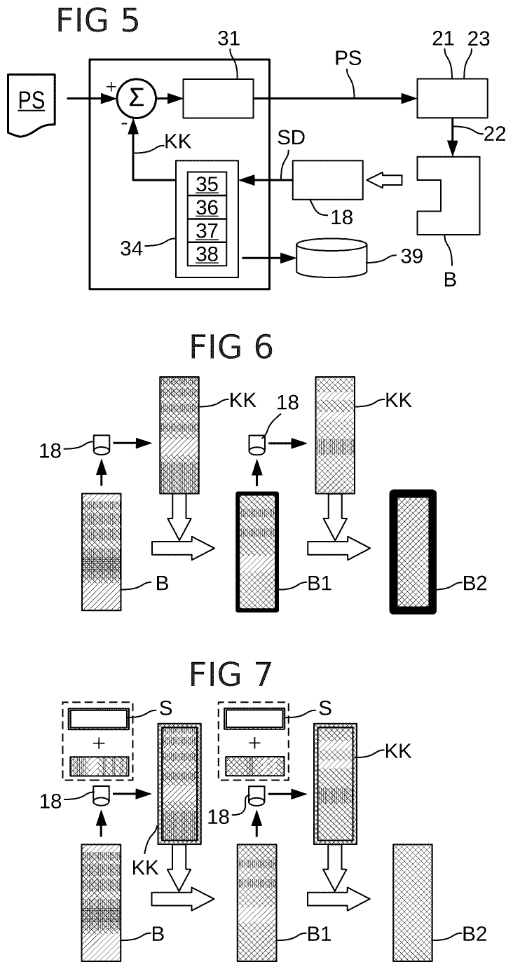

FIG. 5 components for manufacturing a component,

FIG. 6 a normal correction of control data according to the state of the art,

FIG. 7 an optimized correction of control data.

The following embodiments are described with reference to a device 1 for additive manufacturing of components in the form of a selective laser sintering or laser melting device, it being explicitly pointed out once again that the invention is not limited to selective laser sintering or laser melting devices. The device is therefore referred to in the following—without limiting the generality—as “manufacturing device” 1 for short.

Such a manufacturing device 1 is shown schematically in FIG. 1. The device has a process chamber 3 or a process space 3 with a chamber wall 4, in which the manufacturing process essentially takes place. An upwardly open container 5 with a container wall 6 is located in the process chamber 3. The upper opening of the container 5 forms the current working plane 7. The area of this working plane 7 located inside the opening of the container 5 can be used to construct the object 2 and is therefore referred to as the construction field 8.

The container 5 has a base plate 11 movable in a vertical direction V, which is arranged on a carrier 10. This base plate 11 closes the container 5 at the bottom and thus forms its base. The base plate 11 can be formed integrally with the carrier 10, but it can also be a plate formed separately from the carrier 10 and attached to the carrier 10 or simply mounted on it. Depending on the type of specific building material, for example the powder used, and the manufacturing process, a building platform 12 can be attached to the base plate 11 as a building base on which the object 2 is built. In principle, however, the object 2 can also be built on the base plate 11 itself, which then forms the building base.

The basic construction of the object 2 is carried out by first applying a layer of building material 13 to the building platform 12, then—as explained later—selectively solidifying the building material 13 with a laser beam 22 as an energy beam at the points which are to form parts of the object 2 to be manufactured, then lowering the base plate 11, and thus the building platform 12, with the aid of the carrier 10 and applying a new layer of the building material 13 and selectively solidifying it, and so on. In FIG. 1, the object 2 built up in the container on the building platform 12 below the working level 7 is shown in an intermediate state. It already has several solidified layers, surrounded by unconsolidated building material 13. Various materials can be used as building material 13, preferably powder, in particular metal powder, plastic powder, ceramic powder, sand, filled or mixed powders or also pasty materials and optionally a mixture of several materials.

Fresh building material 15 is located in a storage container 14 of the production device 1. The building material can be applied in the working plane 7 or within the construction field 8 in the form of a thin layer with the help of a layering device 16 that can be moved in a horizontal direction H.

Optionally, there is an additional radiation heater 17 in the process chamber 3, which can be used to heat the applied building material 13 so that the irradiation device used for selective solidification does not have to introduce too much energy. This means, for example, that a quantity of basic energy can already be introduced into the building material 13 with the aid of the radiation heater 17, which is of course still below the energy required for the building material 13 to fuse or sinter. For example, an infrared heater or VCSEL emitter can be used as the radiation heater 17.

For selective solidification, the manufacturing device 1 has an irradiation device 20 or, more specifically, an exposure device 20 with a laser 21. This laser 21 generates a laser beam 22, which is deflected by a deflection device 23 in order to scan the exposure paths or tracks (hatch lines) in the layer to be selectively solidified in accordance with the exposure strategy and to selectively introduce the energy. Further, this laser beam 22 is suitably focused onto the working plane 7 by a focusing device 24. The irradiation device 20 is preferably located here outside the process chamber 3 and the laser beam 22 is guided into the process chamber 3 via a coupling window 25 provided in the chamber wall 4 at the top of the process chamber 3.

For example, the irradiation device 20 may comprise not just one, but several lasers. Preferably, these may be gas or solid-state lasers or any other type of laser such as laser diodes, in particular VCSEL (Vertical Cavity Surface Emitting Laser) or VECSEL (Vertical External Cavity Surface Emitting Laser) or a line of these lasers. Most preferably, one or more unpolarized single-mode lasers, e.g. a 3 KW fiber laser with a wavelength of 1070 nm, can be used in the context of the invention.

The manufacturing process is monitored by the sensor arrangement 18. This can comprise, for example, a radiation sensor, e.g. a thermal imaging camera, and measures spatially resolved thermal data of a number of areas of a component layer B.

The units of the manufacturing device 1 are controlled by a control device 30 comprising a control unit 29, which controls the components of the irradiation device 20, namely in this case the laser 21, the deflection device 23 and the focusing device 24, and transmits corresponding control data PS to them for this purpose.

The control unit 29 also controls the radiation heating 17 by means of suitable heating control data HS, the layering device 16 by means of layering control data ST and the movement of the carrier 10 by means of carrier control data TS, thus controlling the layer thickness.

The control device 30 is coupled, here for example via a bus 60 or another data connection, to a terminal 40 with a display or the like. Via this terminal 40, an operator can control the control device 30 and thus the entire laser sinter device 1, for example by transmitting process control data PS.

In order to optimize the production process, the control data PS are generated or modified by means of a control data generating device 34 in the manner according to the invention in such a way that the control of the device 1 takes place at least temporarily in a mode according to the invention.

The control data generation device 34 here comprises a data interface 35 designed to receive a process room control data set KD comprising information on an intended shape F of the currently solidified component layer B, and the process room sensor data set SD of the currently solidified component layer B of the component 2 (see e.g. FIG. 3). The process room sensor data set SD comprises the spatially resolved thermal data recorded by the sensor arrangement 18.

Furthermore, the control data generation device 34 comprises a registration unit 36 designed to define a number of special areas S in the intended shape F, each special area S being an area with predetermined, systematic shape features and/or manufacturing features in the component layer B. In addition, the registration unit 36 is designed to assign the number of special areas S to corresponding areas of the number of areas in the process room sensor data set SD.

In addition, the control data generation device 34 comprises a module unit 37, laid out for generating a correction factor map KK as a correction factor module KK. This correction factor map KK assigns correction factors KF or the corrected irradiation values to at least a partial area of a subsequent component layer B1. The correction factors KF or corrected irradiation values are generated from the process room sensor data set SD and are generated in the special areas S according to different rules than outside the special areas S.

Furthermore, the control data generation device 34 comprises a correction unit 38 designed for correcting control data PS for the additive manufacturing of a subsequent component layer B1 based on the correction factor map KK.

In this example, the corrected control data PS can then be output to the device 1 for the additive manufacturing of a component 2 via the data interface 35, although another data interface can also be used for this purpose.

At this point, it is also pointed out once again that the present invention is not limited to such a manufacturing device 1. It can be applied to other methods for generative or additive manufacturing of a three-dimensional object by layer-by-layer deposition and selective solidification of a building material, wherein an energy beam for solidification is emitted onto the building material to be solidified. Accordingly, the irradiation device can not only be a laser, as described here, but any device could be used with which energy can be selectively applied to or into the building material as wave or particle radiation. For example, another light source, an electron beam, etc. could be used instead of a laser.

Even if only a single object 2 or component 2 is shown in FIG. 1, it is possible and generally also common to produce several objects in the process chamber 3 or in the container 5 in parallel. For this purpose, the building material is scanned layer by layer by the energy beam 22 at points that correspond to the cross-sections of the objects in the respective layer.

FIG. 2 shows a sketch of an energy input and correction factors KF at the edge of a component layer B. The arrow at the bottom indicates a spatial component, the arrow on the left a strength value. The solid vertical line symbolizes the edge of the component layer B and the adjacent dashed line the boundary of a special area S, which lies between these two lines. The area between the dashed line and the dash-dotted vertical line can be regarded as an adjacent normal area.

The solid lines show two possible temperature curves in a process room sensor data set SD, with the upper line showing a temperature curve of an overheated component edge area and the lower line showing a temperature curve in a non-overheated component edge area.

The dashed lines show two possible correction factors KF for the respective solid lines, if a special area (component edge area) would not be treated separately, but analogous to the component interior area (no special area). The dotted lines in the middle show the changed correction factors for the component edge area (special area S) for the two cases mentioned above.

FIG. 3 shows a possible process room sensor data set SD (left) for a component layer B and its intended shape F in a process room control data set KD (right). At their ends, the process room sensor data set SD of component layer B shows areas where overheating has occurred (shaded darker). These inhomogenities in the temperature distribution can be compensated for in subsequent layers, especially if a special area S is shown in the intended shape F (see FIGS. 6 and 7). The two arrows indicate that the intended shape can be segmented into a “normal area” (shown below, without outline) and a special area S (outline only).

It should be noted that the overheated areas are not regarded as special areas S, as the overheating in the “interior” can be counteracted during the production of the next component layer by means of an easily determined correction factor KF (see, for example, the procedure in FIG. 4). At the edge R, however, the situation is different. Here, the correction factor KF must be determined in a different way, e.g. by interpolation or by using correction factors KF of neighboring inner areas. Therefore, the edge R is considered a special area S.

FIG. 4 shows a block diagram of a possible process sequence of an embodiment example of a method according to the invention for generating control data PS for a device 1 for additive manufacturing of a component 2 in a manufacturing process (see FIG. 1), in which the component 2 is built up in a construction field 8 in the form of component layers B by selective solidification of building material 13, e.g. comprising a metal-based powder, by irradiation of the building material 13 with at least one energy beam 22.

In step I, a process room sensor data set SD of a currently solidified component layer B of the component 2 is recorded by means of a sensor arrangement 18, wherein the process room sensor data set SD comprises at least spatially resolved thermal radiation data of a number of regions of this component layer B.

In step II, a process room control data set KD with information on an intended shape F of the currently solidified component layer B is provided. This can, for example, be based on CAD data of the component 2 or from predetermined control data PS.

In step III, a number of special areas S are defined in the intended shape F, each special area S being an area with predetermined, systematic shape features and/or manufacturing features in the component layer B. Here, the component edge area of the component layer B is marked with a dashed line as a special area.

In step IV, the number of special areas S is assigned to corresponding areas of the number of areas in the process room sensor data set SD. This can be done, for example, by means of image registration. In the process room sensor data set SD, different hatchings can be recognized in the component layer. These are intended to symbolize different measured temperatures or radiated heat quantities.

In step V, a correction factor map KK is generated as a correction factor module KK, which assigns correction factors KF or corrected irradiation values to at least a partial area of a subsequent component layer B1 (see e.g. FIGS. 6 and 7). Here, for example, correction factors KF are generated by selecting a value for “normal” areas that is lower the warmer the corresponding area of the component layer B was in step IV. The procedure is different for the special area S. Here, the correction factors KF of neighboring “normal” areas could be used for the correction factors KF or the correction factors KF could be formed from predefined, constant correction factors KF. However, they could also be determined by interpolating methods or based on a model of a theoretical temperature change.

In this step V, the (original) control data PS for the additive manufacturing of a subsequent component layer B1 is corrected based on the correction factor map KK.

As a result of the process, the corrected control data PS is output again to the device for additive manufacturing of the component 2 for manufacturing the next component layer.

FIG. 5 shows components for manufacturing a component 2, which can be arranged in the manufacturing device 1 or linked to it. In contrast to FIG. 1, a simplified representation has been selected here, which only shows the components that are most important for the process. The irradiation control interface 31 and the control data generation device 34 with data interface 35, registering unit 36, module unit 37 and correction unit 38 can again be seen in the bold box on the left. These receive control data PS from the left, which is corrected by correction factor maps KK as correction factor modules KK and sent in corrected form to the irradiation control interface 31. The sensor arrangement 18 supplies the necessary process room sensor data set SD. The deflection device 23 and the laser 21 are then controlled according to the corrected control data PS to produce the next component layer B with the energy beam 22. The correction factor maps KK are still stored here in the memory unit 39.

FIGS. 6 and 7 sketch a correction of control data PS. The bottom line shows the spatially resolved thermal data of several directly superimposed building sublayers B, B1, B2. These are recorded by the sensor arrangement 18 as a process space sensor data set SD and correction factor maps KK are created as correction factor modules KK according to the procedure outlined in FIG. 4 (top line). It can be seen that the correction factor maps KK look like a negative image of the heat distributions. This is due to the fact that if the local heat at this point is too high, less energy should be introduced in the next production step.

In FIG. 6, a normal correction is applied without taking special areas S into account. It can be seen that a homogeneous temperature distribution occurs within the inner surface of the component layer (component layer B2 bottom right), but that the edge experiences too much energy input (indicated by a thick edge line). However, this is not perceived by the sensor arrangement 18, as it also “sees” unconsolidated areas at the edge and mixes their temperature with the temperature of the edge area due to the limited resolution.

FIG. 7 shows an optimized correction with consideration of special areas S. Here, the edge area is considered a special area S and the correction factors there are determined differently, e.g. by using correction factors of adjacent inner areas. This results in a good homogeneity of the temperature distribution even in the edge area (component layer B2 bottom right).

Finally, it should be pointed out once again that the devices described in detail above are merely examples of embodiments which can be modified in various ways by a person skilled in the art without departing from the scope of the invention. For example, solidification could also be carried out using other energy beams instead of laser light. Furthermore, the use of the indefinite articles “a” or “one” does not exclude the possibility that the features in question may be present more than once. Likewise, the term “unit” does not exclude the possibility that it consists of several interacting sub-components, which may also be spatially distributed. The term “a number” is to be understood as “at least one”.

### LIST OF REFERENCE SYMBOLS

1 Device for additive manufacturing/laser sinter device
2 Component/object
3 Process space/process chamber
4 Chamber wall
5 Container
6 Container wall
7 Working plane
8 Construction field
10 Carrier
11 Base plate
12 Building platform
13 Building material (in container 5)
14 Storage container
15 Building material (in storage container 14)
16 Layering devices
17 Radiation heater
18 Sensor arrangement
20 Irradiation device/exposure device
21 Laser
22 Laser beam/energy beam
23 Deflection device/scanner
24 Focusing device
25 Coupling windows
29 Control unit
30 Control device
31 Irradiation control interface
34 Control data generation device
35 Data interface
36 Registering unit
37 Module unit
38 Correction unit
39 Memory unit
40 Terminal
60 Bus
B, B1, B2 Component layer
F Intended shape
H horizontal direction
HS Heating control data
KD Process room control data set
KF Correction factor
KK correction factor map/correction factor module
PS Process control data
S Special area
SD Process room sensor data set
ST Layering control data
TS Carrier control data
V vertical direction

1. A method for generating control data for a device for additive manufacturing of a component in a manufacturing process, in which building material, is built up layer by layer in a construction field by selective solidification of building material by irradiation of the building material with at least one energy beam, the method comprising the steps:
recording of a process room sensor data set with spatially resolved thermal data of a currently solidified component layer,
providing a process room control data set of a currently solidified component layer of the component by means of a sensor arrangement, wherein the process room sensor data set comprises at least spatially resolved thermal data of a number of regions of this component layer,
providing a process room control data set comprising information on an intended shape of the currently solidified component layer,
defining a number of special areas in the intended shape, each special area being an area having predetermined, systematic shape features and/or manufacturing features in the component layer,
assigning the number of special areas to corresponding areas of the number of areas in the process room sensor data set,
generating a correction factor module which assigns correction factors or the corrected irradiation values to at least a partial area of a subsequent component layer, wherein the correction factors or corrected irradiation values are generated from the process room sensor data set and are generated in the special areas according to different rules than outside the special areas,
correcting control data for the additive manufacturing of a subsequent component layer based on the correction factor module,
outputting the corrected control data to a device for additive manufacturing of a component.

2. The method according to claim 1, wherein before assigning the number of special areas to the corresponding areas in the process room sensor data set, the process room sensor data set is adapted according to existing calibration data or according to an adaptation function, preferably wherein
the sensor arrangement is first calibrated and the process room sensor data set is recorded with the calibrated sensor arrangement, or
predefined calibrating data is present and the process room sensor data set is adjusted after it has been recorded by the sensor arrangement,
wherein, the special areas are registered to corresponding areas in the process room sensor data set or otherwise mapped there by using a matching algorithm.

3. The method according to claim 1, wherein at least one special area
is a component edge area of the component layer, and/or
is an area of the component layer in which solidification paths overlap with each other, and/or
is an area in which a hatching strip tapers, and/or
is an area smaller than the optical resolution of the sensor arrangement, and/or
is an area with support structures.

4. The method according to claim 1, wherein the assignment of the number of special areas to the corresponding positions in the process room sensor data set is carried out by means of an image registration.

5. The method according to claim 1, wherein the correction factors of the correction factor module for a special area
are interpolated or extrapolated from the correction factors for a number of component areas of the intended shape adjacent to the special area by interpolating correction factors of opposite component areas or of a component area and predetermined values outside the component, or correction factors of a component area are used,
are formed from predefined, constant correction factors,
are determined by interpolating methods from image processing that are based on a continuous continuation of the gray values,
are generated based on a model of a theoretical temperature change.

6. The method according to claim 1, wherein predetermined maximum and/or minimum values for a correction factor are present, and the correction factors are generated in such a way that they do not exceed the maximum values and/or do not fall below the minimum values.

7. The method according to claim 1, wherein for generating the correction factor module the correction factors are generated from the process room sensor data set outside the number of special areas by means of a controller, and within the number of special areas
are generated without the controller, or
are first generated using the controller and then corrected or
first, the corresponding values of the process room sensor data set are corrected and then the correction factors are generated using the controller.

8. The method according to claim 1, wherein the method is applied to a plurality of successive component layers wherein control data are stored together with a number of corresponding correction factor modules and/or corrected control data,
wherein for the correction of control data for a component
only data of the correction factor module generated from a component layer of this component is used, or
data of a correction factor module generated from a uniform component layer of another component can be used.

9. The method according to one claim 1, wherein in order to determine a number of special areas in the currently solidified component layer in addition to a process room control data set, information on a shape and/or position of the subsequent component layer is provided and correction factors for downskin areas are derived from the process room control data sets of both component layers.

10. Control data for controlling a device for additive manufacturing which has been corrected according to a method according to claim 1.

11. A manufacturing method for additively manufacturing a component, wherein building material is built up layer by layer in a construction field by selective solidification of building material by irradiation of the building material with at least one energy beam in accordance with the control data according to claim 10, wherein the energy beam is moved over the construction field within defined areas in accordance with said control data to create component layers of the component.

12. A control data generation device for generating control data according to claim 10 for a device for additive manufacturing of a component in a manufacturing process, in which building material is built up layer by layer in a construction field by selective solidification of building material by irradiation of the building material with at least one energy beam, comprising the control data generation device :
a data interface designed to receive a process room control data set comprising information on an intended shape of the currently solidified component layer, and a process room sensor data set of a currently solidified component layer of the component recorded by means of a sensor arrangement, wherein the process room sensor data set comprises at least spatially resolved thermal data of a number of regions of this component layer,
a registering unit designed for defining a number of special areas in the intended shape, each special area being an area having predetermined systematic shape features and/or manufacturing features in the component layer, and for assigning the number of special areas to corresponding areas of the number of areas in the process room sensor data set,
a module unit designed for generating a correction factor module which assigns correction factors or the corrected irradiation values to at least a partial area of a subsequent component layer, wherein the correction factors or corrected irradiation values are generated from the process room sensor data set and are generated in the special areas according to different rules than outside the special areas,
a correction unit designed for correcting control data for the additive manufacturing of a subsequent component layer based on the correction factor module,
a data interface designed for outputting the corrected control data to a device for additive manufacturing of a component.

13. A control device for a device for additive manufacturing of a component in a manufacturing process, in which building material is built up layer by layer in a construction field by selective solidification of building material by irradiation of the building material with at least one energy beam by means of an irradiation device,
wherein the control device is designed to control the device for additive manufacturing of the component layers of the component in accordance with control data according to claim 10, wherein the control device comprises a control data generation device.

14. A device for additive manufacturing of at least one component in an additive manufacturing process with at least
a feeding device for applying layers of building material to a construction field in a process space,
an irradiation device for selectively solidifying building material by irradiation with at least one energy beam, and
a control device according to claim 13.

15. A computer program product comprising instructions which, when the program is executed by a computer, cause the computer to perform the steps of the method according to claim 1.
